(19) United States
(12) Patent Application Publication
(10) Pub. No.: US 2009/0314061 A1
(43) Pub. Date: Dec. 24, 2009

(54) Pressure-Measuring Device

(76) Inventors: Christoph Kern, Aspach (DE); Reiko Zach, Remseck (DE); Michael Kleindl, Schwieberdingen (DE); Steffen Schott, Schwieberdingen (DE); Pavlo Saltikov, Waiblingen (DE)

Correspondence Address: KENYON & KENYON LLP, ONE BROADWAY, NEW YORK, NY, 10004, US

(21) Appl. No.: 12/223,348

(22) PCT Filed: Jan. 12, 2007
(86) PCT No.: PCT/EP2007/050282

§ 371 Date: Dec. 11, 2008

(30) Foreign Application Priority Data
Feb. 21, 2006 (DE) 102006008350.4

(51) Int. Cl. G01L 23/22

(52) U.S. Cl. 73/35.12

(57) ABSTRACT

A pressure-measuring device is used for placing in a chamber of an internal combustion engine. The pressure-measuring device has a housing, a force-transmitting element in operative connection with a pressure sensor, and a centering element. The pressure sensor is placed, together with contact plates, on a centering section of the centering element, thereby making it possible to position the pressure sensor and the contact plates within the housing of the pressure-measuring device. The assembly of the pressure-measuring device is thereby facilitated, and a preassembly is possibly allowed.

### FIELD OF THE INVENTION

The present invention relates to a pressure-measuring device for placing in a chamber of an internal combustion engine. In particular, the present invention relates to a pressure-measuring glow plug for placing in a prechamber, swirl chamber or combustion chamber of an air-compressing, autoigniting internal combustion engine.

### BACKGROUND INFORMATION

German Patent No. DE 103 43 521 describes a pressure-measuring glow plug for a diesel engine. The known pressure-measuring glow plug has a plug shell for insertion into a cylinder of the diesel engine. The pressure-measuring glow plug described also has a heating pin disposed in the plug shell and a sensor arrangement. The sensor arrangement is under prestress between the plug shell and a contact conduit which is connected to the heating pin, a clamping element being provided which is screw-fitted to the contact conduit. The sensor arrangement abuts on one side against the clamping element, and on the other side against the plug shell. The sensor arrangement is used for measuring a pressure in the combustion chamber of the cylinder, which is transmitted via the heating pin and the contact conduit. The known pressure-measuring glow plug further has a membrane which is joined on one side to the plug shell and on the other side to the heating pin, in order to seal off the sensor arrangement from the combustion chamber.

The pressure-measuring glow plug described in German Patent No. DE 103 43 521 has the disadvantage that when assembling the pressure-measuring glow plug, a multitude of individual parts must be joined together and positioned in coordination with each other. Therefore, the assembly turns out to be relatively costly. There is also the disadvantage that the operativeness of the pressure-measuring glow plug can only be checked after assembly is completed. In particular, errors which occur with regard to an individual function of the pressure-measuring glow plug, especially the pressure measurement, end in the entire assembled pressure-measuring glow plug having to be treated as a reject.

### SUMMARY OF THE INVENTION

The pressure-measuring device of the present invention has the advantage that the assembly of the pressure-measuring device is simplified, and in particular, preassembly of parts of the pressure-measuring device is made possible.

The centering element of the pressure-measuring device has a centering section on which the pressure sensor and possibly further components of the pressure-measuring device are able to be mounted, especially slipped on. The centering element thereby allows preassembly of components which are used directly or indirectly for measuring pressure when the pressure-measuring device is assembled. In this context, if applicable, a functional check of such an intermediate product is also possible during the manufacturing of the pressure-measuring device, so that possible sources of error with regard to the pressure measurement may already be recognized prior to the final assembly of the pressure-measuring device. Moreover, the centering section makes it possible to center the components, especially the pressure sensor, mounted on the centering section, thus facilitating the final assembly of the pressure-measuring device. Furthermore, requisite gap dimensions of gaps which are necessary for the electrical isolation, e.g., with regard to the housing of the pressure-measuring device, are reliably maintained because of the centering and positioning ensured by the centering section of the centering element. The centering element ensures this positioning and centering even during operation of the pressure-measuring device, e.g., upon the occurrence of vibrations or impacts acting on the housing.

It is advantageous that a first contact plate is provided which is used for the electrical connection of a first measuring line to the pressure sensor and which has a through-cutout; that a second contact plate is provided which is used for the electrical connection of a second measuring line to the pressure sensor and which has a through-cutout; and that the contact plates are placed, together with the pressure sensor, on the centering section of the centering element, the pressure sensor being disposed between the contact plates. The contact plates, together with the pressure sensor, may be slipped onto the centering section of the centering element in the course of a preassembly operation. This preassembled intermediate product may then be inserted into the housing of the pressure-measuring device for the final assembly. Positioning, especially centering of the contact plates and the pressure sensor in the housing of the pressure-measuring device is then ensured by the centering section. In this context, if applicable, a defined annular gap may be ensured between the pressure sensor and the contact plates with respect to the electrically conductive housing of the pressure-measuring device, so that the operativeness of the pressure-measuring device is ensured, even after the occurrence of vibrations or impacts on the housing. At the same time, it is advantageous that the centering section has one or more cutouts in which the tabs of the contact plates engage in order to permit anti-rotational positioning of the contact plates in relation to the centering section of the centering element, and therefore in relation to the housing of the pressure-measuring device, as well. In this manner, twisting of electrical measuring lines which are assigned to the contact plates is also prevented. To further reduce the influence of mechanical forces on the measuring lines, they may also be guided in the cutouts of the centering section. This prevents a connection between a measuring line and a tab of a contact plate, or a connecting point within a measuring line from breaking or being damaged in some other way because of mechanical stress.

Advantageously, the centering element has a through-opening which, in particular, extends through the centering section of the centering element, a current lead being run in the through-opening of the centering element through the centering element. First of all, a defined position of the current lead within the housing of the pressure-measuring device is thereby ensured. Secondly, the centering element allows a certain shielding of the current lead, particularly with regard to the pressure sensor. Especially in the case of a pressure-measuring device implemented as a pressure-measuring glow plug in which the current lead is used as the glow-plug current lead, it is possible that a sensor signal of the piezoelectric pressure sensor will be influenced electromagnetically because of the considerable flow of current through the glow-plug current lead. The electric fields caused by the current through the current lead may be attenuated by a suitable selection of the materials for the centering element, to the extent that the influencing of the sensor signal of the pressure sensor is prevented or at least reduced. A reliable pressure measurement is thereby made possible, even during the heating operation of the pressure-measuring glow plug. In this context, it is particularly advantageous if the through-opening of the centering element is formed as an inner opening disposed centrally in relation to the existing or remaining wall thickness of the centering element, so that the minimum of the wall thickness is maximal in the radial directions in order to achieve optimized shielding in every radial direction.

In addition to the pressure sensor and the contact plates, further components of the pressure-measuring device may also be slipped on the centering section. In particular, one or more insulating elements may be provided. One insulating element in particular may be provided, which electrically insulates one of the contact plates with respect to the fixing element.

The centering element may be made of a ceramic having a high content of aluminum oxide. Further, the centering element may be made of an aluminum oxide or a mixture with aluminum oxide, especially with more than 99% aluminum oxide. Advantageously, the centering element may also be made of a steatite, thus a material based on soapstone (Protoenstatit, Mg(Si4O10)(OH)2). Zirconium oxide, particularly fully stabilized zirconium oxide (FSZ), partially stabilized zirconium oxide (PSZ) or polycrystalline tetragonal zirconium oxide (TZP), is also suitable as material for the centering element, in connection with which, stabilizers such as magnesium oxide, calcium oxide or yttrium oxide may be used. A further material for the centering element is zirconium-oxide-fortified aluminum oxide (ZTA), in which different mixtures having different portions of zirconium oxide and aluminum oxide may be selected.

### BRIEF DESCRIPTION OF THE DRAWINGS

FIG. 1 shows an exemplary embodiment of a pressure-measuring device according to the present invention in a schematic sectional view.

FIG. 2 shows a section of the pressure-measuring device according to the exemplary embodiment of the present invention in an exploded view.

FIG. 3 shows a section from the pressure-measuring device of the exemplary embodiment of the present invention from the direction of view denoted by III in FIG. 2.

### DETAILED DESCRIPTION

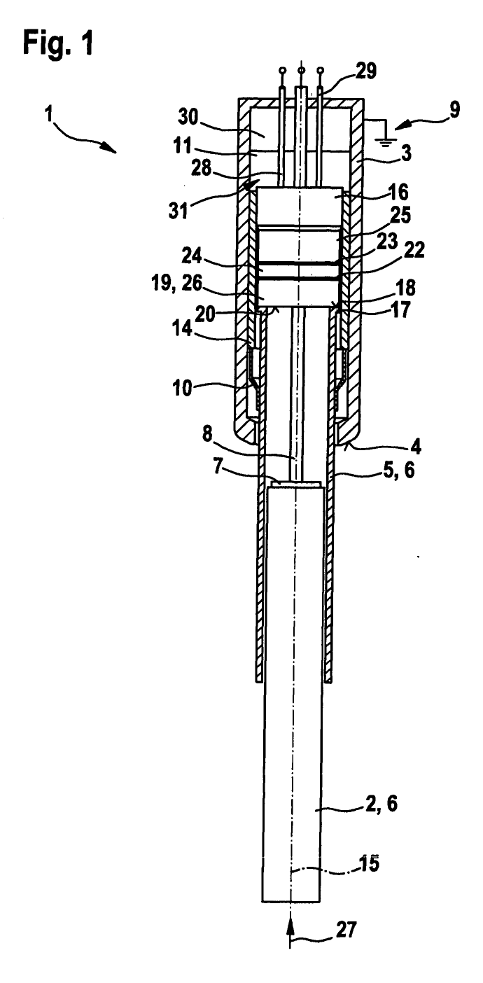

FIG. 1 shows a first exemplary embodiment of a pressure-measuring device 1 in an axial sectional view. In this case, pressure-measuring device 1 is implemented as pressure-measuring glow plug 1 for an air-compressing, autoigniting internal combustion engine. A bar-shaped heating element 2 of pressure-measuring glow plug 1 projects into the chamber of the internal combustion engine in the case of prechamber and swirl-chamber engines, and into a combustion chamber of the engine in the case of engines having direct injection. However, pressure-measuring glow plug 1 according to the present invention is suitable for other application cases, as well. Moreover, pressure-measuring device 1 may also be implemented as a pressure-measuring spark plug or pressure-measuring injector for mixture-compressing internal combustion engines having externally supplied ignition.

Pressure-measuring glow plug 1 has a housing 3 having a sealing cone 4. Bar-shaped heating element 2 is surrounded sectionally by a force-transmitting element 5 and is joined to it. Bar-shaped heating element 2, together with force-transmitting element 5, forms a glow element 6 of pressure-measuring glow plug 1. Bar-shaped heating element 2 of glow element 6 is joined with the aid of a contact element 7 to a current lead 8 taking the form of glow-plug current lead 8. Glow-plug current lead 8 is connected in a suitable manner to a control unit or the like. Moreover, force-transmitting element 5 of glow element 6 is electrically connected directly or indirectly to housing 3; in the assembled state of pressure-measuring glow plug 1, a connection is able to be produced to electrical ground 9 via housing 3. Relatively large currents, e.g., of several amperes, are able to flow through glow-plug current lead 8 in order to conduct to heating element 2 the energy needed to heat up heating element 2 of glow element 6.

Provided within housing 3 is a metallic membrane 10 that is joined on one side to force-transmitting element 5, and on the other side to a sleeve 14, especially a sensor cage 14. In this context, the diameter of metallic membrane 10 in the area of the connection to the force-transmitting element is smaller than the diameter of metallic membrane 10 in the area of the connection to sleeve 14, so that metallic membrane 10 is able to be prestressed in the axial direction, i.e., in the direction of an axis 15. Sleeve 14 is joined in a suitable manner, e.g., by a welded seam, to housing 3.

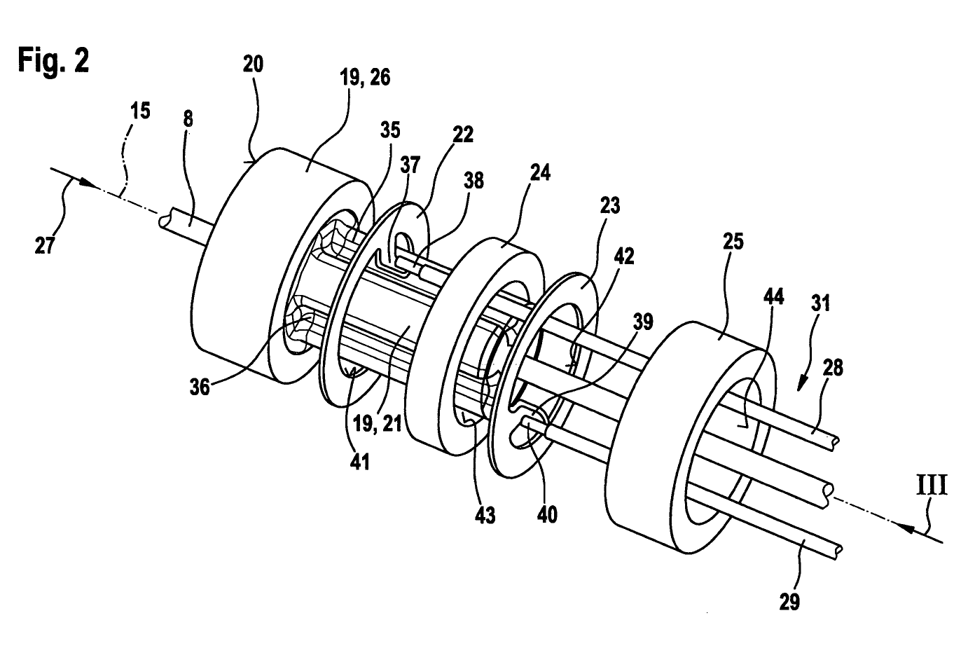

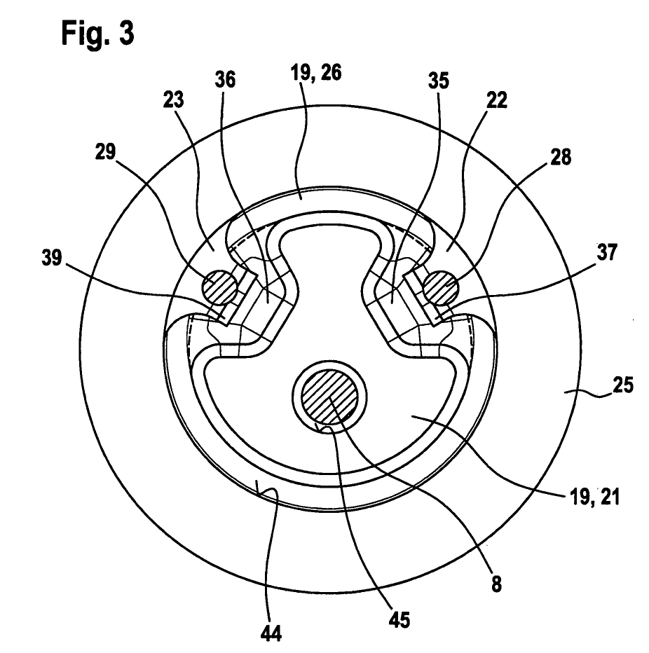

Pressure-measuring glow plug 1 also has a fixing element 16, disposed in an interior space 11 of housing 3, which is joined in a suitable manner, particularly by a welded seam, to sleeve 14. Force-transmitting element 5 of glow element 6 has a collar 17, on which an annular end face 18 is provided. Collar 17 of force-transmitting element 5 is located within housing 3 of pressure-measuring glow plug 1. A centering element 19 is supported on end face 18 of collar 17 of force-transmitting element 5, an end face 20 of centering element 19 abutting partially against end face 18 of collar 17. Centering element 19 has a centering section 21, which is shown in FIGS. 2 and 3. A first contact plate 22, a pressure sensor 24, a second contact plate 23 and an insulating element 25 are slipped one after another onto centering section 21 of centering element 19. Pressure sensor 24 is therefore surrounded by contact plates 22, 23, insulating element 25 electrically insulating second contact plate 23 with regard to fixing element 16, which is made of a conductive material, particularly a steel. Insulating element 25 abuts directly against fixing element 16. Pressure sensor 24 is in operative connection with force-transmitting element 5 of glow element 6 via first contact plate 22 and a cylindrical part 26 of centering element 19. In addition, pressure sensor 24 is supported against fixing element 16 via second contact plate 23 and insulating element 25. In the event force-transmitting element 5 acts upon pressure sensor 24, a, for example, piezoelectric part of pressure sensor 24 generates a measuring charge which is measurable with the aid of measuring lines 28, 29 running from housing 3 to a suitable evaluation circuit. Pressure sensor 24, contact plates 22, 23, insulating element 25 and centering section 21 of centering element 19 are disposed in interior space 11 of housing 3, which is sealed off with respect to the chamber.

Due to a pressure prevailing in the chamber, bar-shaped heating element 2 of glow element 6 is acted upon in an axial direction 27, that is, in the direction of axis 15 of housing 3. The force acting on heating element 2 in this instance is at least substantially transmitted via force-transmitting element 5, centering element 19 and first contact plate 22 to pressure sensor 24, the latter being supported via second contact plate 23 and insulating element 25 against fixing element 16. In this manner, as a function of the pressure in the chamber, a certain electrical charge of pressure sensor 24 is generated which is measurable via measuring lines 28, 29.

Fixing element 16 is joined in such a way to sleeve 14 that a certain prestressing of metallic membrane 10 is predefined in the pressureless state. Due to the prestressing of metallic membrane 10, the individual components within the force path, that is, especially cylindrical part 26 of centering element 19, first contact plate 22, pressure sensor 24, second contact plate 23, insulating element 25 and fixing element 16 rest against each other, hysteresis effects thereby being prevented or at least reduced during the pressure measurement.

A guide element 30 is also provided inside of housing 3. Measuring lines 28, 29, as well as glow-plug current lead 8 are joined mechanically to guide element 30. Measuring lines 28, 29, as well as glow-plug current lead 8 are guided both through centering element 19, as described in greater detail with reference to FIGS. 2 and 3, as well as through guide element 30, and are positioned in relation to housing 3. Therefore, even in the event of vibrations or the occurrence of impacts on housing 3, a short-circuit of or damage to measuring lines 28, 29 or glow-plug current lead 8 is prevented. The resistance to vibration achieved by the guidance of measuring lines 28, 29 also prevents interference components from being coupled into measuring lines 28, 29, especially in the range of several kilohertz. In addition, mechanical connecting points within measuring lines 28, 29 and/or glow-plug current lead 8, e.g., upon the assembly of pressure-measuring glow plug 1 in an area 31 of measuring lines 28, 29 and of glow-plug current lead 8, are protected with regard to mechanical stresses. In addition, twisting of measuring lines 28, 29 and glow-plug current lead 8 is prevented by the guidance, both in the area of centering element 19 and in the area of guide element 30.

Guide element 30 may have further functions. In particular, guide element 30 may have electronic components which convert the charge of pressure sensor 24, measurable via measuring lines 28, 29, into a suitable output signal.

Pin-shaped centering element 19 has cylindrical part 26 and centering section 21. In the course of a preassembly operation, first contact plate 22, pressure sensor 24, second contact plate 23 and insulating element 25 are placed one after another on centering section 21 of centering element 19. Centering section 21 of centering element 19 has a first cutout 35 and a second cutout 36. First contact plate 22 is placed on centering section 21 in such a way that a tab 37 of first contact plate 22 is disposed in first cutout 35. In the preassembled state, tab 37 of first contact plate 22 thereby engages in first cutout 35, so that an anti-rotation element is formed for first contact plate 22. An end section 38 of measuring line 28 is joined, e.g., by soldering or welding, to tab 37 of first contact plate 22. Second contact plate 23 is placed on centering section 21 of centering element 19 in such a way that a tab 39 of second contact plate 23 engages in second cutout 36 of centering section 21, in order to create an anti-rotation element for second contact plate 23. Moreover, an end section 40 of measuring line 29 is joined by welding or soldering to tab 39 of second contact plate 23. In the assembled state, measuring lines 28, 29 pass through first cutout 35 and second cutout 36, respectively, so that measuring lines 28, 29 are supported in cutouts 35, 36. Moreover, contact plates 22, 23, pressure sensor 24 and insulating element 25 are positioned, in particular, are fixed in the radial direction, by being slipped onto centering section 21 of centering element 19, so that a contact between contact plates 22, 23 and pressure sensor 24 with sleeve 14 is prevented in particular, in order to avoid a short-circuit with housing 3.

In addition, glow-plug current lead 8 is guided both through cylindrical part 26 and centering section 21 of centering element 19, as described in greater detail with reference to FIG. 3.

First contact plate 22 has a through-cutout 41, through which centering section 21 extends in the assembled state. Second contact plate 23 also has a through-cutout, through which centering section 21 extends in the assembled state. Pressure sensor 24 has a through-cutout 43 in order to place the pressure sensor on centering section 21 of centering element 19, centering section 21 engaging with cutout 43 of pressure sensor 24 in order to position pressure sensor 24. Correspondingly, centering section 21 also engages with both cutout 41 of first contact plate 22 and cutout 42 of second contact plate 23. Insulating element 25 likewise has a through-cutout 44, so that insulating element 25 may be mounted on centering section 21 of centering element 19.

FIG. 3 shows a representation, in part, of pressure-measuring glow plug 1 of the exemplary embodiment according to the present invention from the direction of view denoted by III in FIG. 2. Centering element 19 has a through-opening 45 which extends both through centering section 21 and cylindrical part 26 of centering element 19. In this context, through-opening 45 is configured as inner opening 45, and is disposed at least substantially centrally in relation to the cross-section of centering section 21 shown in FIG. 3, in order to achieve the most uniform possible, all-round shielding of glow-plug current lead 8. Influencing of the electrical charge of pressure sensor 24, generated during the pressure measurement, which is measurable via measuring lines 28, 29 is thereby prevented or at least reduced.

Centering element 19 is preferably formed from an electrically insulating material. A ceramic having a high specific electrical resistance is suitable for this purpose, in order to prevent a charge of piezoelectric pressure sensor 24 from discharging. Centering element 19 is able to be produced in one piece, and therefore cost-effectively. In particular, centering element 19 may be made of ceramics containing a high content of aluminum oxide, or of an aluminum oxide, especially with a composition of more than 99% aluminum oxide. A steatite based on soapstone (Protoenstatit, Mg(Si4O10)(OH)2) may also be used as material for centering element 19. One or a combination of several zirconium oxides, particularly fully stabilized zirconium oxide, partially stabilized zirconium oxide or polycrystalline tetragonal zirconium oxide may also be used as material. In this case, stabilizers such as magnesium oxide, calcium oxide or yttrium oxide are advantageous for stabilizing the zirconium oxide. An aluminum oxide fortified with zirconium oxide is also suitable as material for centering element 19, mixtures having different portions of zirconium oxide and aluminum oxide being possible. These materials may also be combined with each other.

The modular design of centering element 19 described, having pressure sensor 24, contact plates 22, 23 and the insulating element, permits a short overall axial length of the pressure-measuring module used for measuring pressure, which in addition to these components, also includes metallic membrane 10, a part of force-transmitting element 5, sleeve 14 and fixing element 16. Interfering natural frequencies of the pressure-measuring module may thereby be shifted in the direction of higher frequencies, in order to achieve high reliability of the pressure measurement.

The present invention is not restricted to the exemplary embodiment described.

1-10. (canceled)

11. A pressure-measuring device for placing in a chamber of an internal combustion engine, comprising:
a housing;
a force-transmitting element that projects at least partially out of the housing;
a fixing element;
a pressure sensor situated in an interior space of the housing, wherein to determine a pressure prevailing in the chamber, on one side, the pressure sensor is in operative connection, at least indirectly, with the force-transmitting element, and on the other side, the pressure sensor is supported at least indirectly against the fixing element, the pressure sensor having a through-cutout; and
a centering element having a centering section, the centering element and the pressure sensor being joined together, the centering section of the centering element engaging with the cutout in the pressure sensor in order to position the pressure sensor.

12. The pressure-measuring device according to claim 11, wherein the device is a pressure-measuring glow plug for an air-compressing, autoigniting internal combustion engine.

13. The pressure-measuring device according to claim 11, further comprising:
a first contact plate for providing an electrical connection of a first measuring line to the pressure sensor and having a through-cutout; and
a second contact plate for providing an electrical connection of a second measuring line to the pressure sensor and having a through-cutout,
wherein the contact plates are situated, together with the pressure sensor, on the centering section of the centering element, the pressure sensor being situated between the contact plates.

14. The pressure-measuring device according to claim 13, wherein the centering section of the centering element has at least a first cutout, and a tab of the first contact plate engages in the first cutout of the centering section of the centering element.

15. The pressure-measuring device according to claim 14, wherein a first measuring line is joined, by welding or soldering, to the tab of the first contact plate, and the first measuring line is guided in the first cutout of the centering section of the centering element.

16. The pressure-measuring device according to 13, wherein the centering section of the centering element has a second cutout, a tab of the second contact plate engages in the second cutout of the centering section of the centering element, a second measuring line is joined to the tab of the second contact plate, and the second measuring line is guided in the second cutout of the centering section of the centering element.

17. The pressure-measuring device according to 11, wherein the centering element has a through-opening that extends through the centering section of the centering element, and a glow-plug current lead is guided through the centering element in the through-opening of the centering element.

18. The pressure-measuring device according to claim 17, wherein the through-opening of the centering element is configured as an inner opening.

19. The pressure-measuring device according to claim 18, wherein the inner opening of the centering element is situated at least substantially in a middle of a cross-section of the centering section of the centering element.

20. The pressure-measuring device according to claim 11, further comprising at least one insulating element having a through-cutout and permitting an electrical insulation with respect to a fixing element, and the insulating element is situated, together with the pressure sensor, on the centering section of the centering element.

21. The pressure-measuring device according to claim 20, wherein the centering element is made of at least one of (a) a material which has a ceramic having aluminum oxide, (b) an aluminum oxide, (c) a steatite, (d) a zirconium oxide, (e) a magnesium oxide, (f) a calcium oxide and (g) a yttrium oxide.
